(19) United States
(12) Patent Application Publication
(10) Pub. No.: US 2014/0118568 A1
(43) Pub. Date: May 1, 2014

(54) METHOD AND APPARATUS FOR PROCESSING IMAGE

(71) Applicant: SAMSUNG ELECTRONICS CO., LTD., Suwon (KR)

(72) Inventors: Young Su Moon, Seoul (KR); Shi Hwa Lee, Seoul (KR)

(73) Assignee: SAMSUNG ELECTRONICS CO., LTD., Suwon (KR)

(21) Appl. No.: 13/965,456

(22) Filed: Aug. 13, 2013

(30) Foreign Application Priority Data
Oct. 29, 2012 (KR) 10-2012-0120532

(51) Int. Cl. H04N 5/232

(52) U.S. Cl. CPC H04N 5/23267; H04N 5/23254
USPC 348/208.6

(57) ABSTRACT

A method and apparatus for processing an image based on a tile image is disclosed, the method including estimating first motion information indicating a degree of a motion of a target image with respect to a reference image, dividing the reference image and the target image into a plurality of reference tile images and a plurality of target tile images, performing an image processing on the plurality of target tile images using the first motion information, and combining the plurality of image processed target tile images.

### CROSS-REFERENCE TO RELATED APPLICATIONS

This application claims the priority benefit of Korean Patent Application No. 10-2012-0120532, filed on Oct. 29, 2012, in the Korean Intellectual Property Office, the disclosure of which is incorporated herein by reference.

### BACKGROUND

1. Field

One or more example embodiments relate to a method and apparatus for processing an image that performs image processing using a plurality of images.

2. Description of the Related Art

In general, two types of image quality degradation issues may arise when capturing an image with an image capturing apparatus such as a camera under a low luminance condition, such as, a dark environment with a relatively low illumination. A first such issue arises when the capturing is performed by setting a long exposure time to achieve a sufficient exposure. This is because, as a shutter speed becomes longer, motion blur may occur due to shaking of the image capturing apparatus or a motion of an object during the long exposure time. A second such issue arises when the capturing is performed by setting a short exposure time, since a color distortion issue may arise along with strong image noise.

To solve the image quality degradation issue of an image captured under the low luminance conditions, technology for removing motion blur and high-efficiency technology for removing noise, and the like, have been developed based on a single resulting image.

Against this backdrop, technology for capturing a plurality of images rather than a single image to process the plurality of images through synthesis is being developed. For example, image quality degradation may occur when capturing a plurality of images with a hand-held camera due to shaking of the hands of the photographer or due to a motion of an object, and technology for using a plurality of images may be employed to compensate for the image quality degradation.

With a recent increase in a sensor resolution of a digital camera, a corresponding gradual increase in a size of a memory required by a processor in a camera is also present. Still, research into developing technology for processing an input image by dividing the input image into a plurality of tile images is being conducted because increasing the size of the memory in proportion to a size of the input image is limited. Nonetheless, in estimating relative geometric position information between the plurality of tile images based on the plurality of tile images, when global motion information estimated based on the plurality of tile images differs from each other, the image quality degradation may occur in the output image. Accordingly, there is a need for technology for preventing the image quality degradation in a tile image-based image processing.

### SUMMARY

The foregoing and/or other aspects are achieved by providing a method for processing an image, the method including estimating first motion information indicating a degree of motion of a target image with respect to a reference image, dividing the reference image and the target image into a plurality of reference tile images and a plurality of target tile images, performing an image processing on the plurality of target tile images using the first motion information, and combining the image-processed target tile image.

The performing of the image processing may include estimating second motion information indicating a degree of motion of the target tile image with respect to the reference tile image using the first motion information, dividing the reference tile image and the target tile image into a plurality of block areas, searching for a block area of the target tile image that matches a block area of the reference tile image using the second motion information, and performing the image processing on the target tile image using a pixel value of the block area found in the reference tile image and a pixel value of the block area found in the target tile image.

The method for processing the image may further include adjusting a brightness of the target image for a brightness of the target image to match a brightness of the reference image.

The foregoing and/or other aspects are achieved by providing an apparatus for processing an image, the apparatus including a first motion information estimating unit to estimate first motion information indicating a degree of motion of a target image with respect to a reference image, a tile image dividing unit to divide the reference image and the target image into a plurality of reference tile images and a plurality of target tile images, a tile image processing unit to perform the image processing on the plurality of target tile images using the first motion information, and a tile image combining unit to combine the plurality of image processed target tile images.

The tile image processing unit may include a second motion information estimating unit to estimate second motion information indicating a degree of motion of the target tile image with respect to the reference tile image using the first motion information, a block area dividing unit to divide the reference tile image and the target tile image into a plurality of block areas, and a block area detecting unit to detect a block area of the target tile image that matches a block area of the reference tile image using the second motion information.

The apparatus for processing the image may further include a brightness adjusting unit to adjust a brightness of the target image for a brightness of the target image to match a brightness of the reference image.

The foregoing and/or other aspects are achieved by providing an image processing method including the operations of estimating, by way of a processor, motion information between a plurality of input images by estimating a cumulative pixel value of each of the plurality of input images in a predetermined direction, dividing each of the plurality of input images into a plurality of sub-images, performing image processing on the plurality of sub-images using the estimated motion information, and combining the image-processed sub-images into a single output image.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates an overall operation of an apparatus for processing an image according to example embodiments;

FIG. 2 illustrates a detailed configuration of an apparatus for processing an image according to example embodiments;

FIG. 3 illustrates an example of generating a cumulative image one dimensional (1D) curve according to example embodiments;

FIGS. 4A and 4B illustrate examples of estimating first motion information according to example embodiments;

FIGS. 5A and 5B illustrate operations of estimating first motion information with respect to a translational movement and a rotational movement according to example embodiments;

FIG. 6 illustrates an example of dividing an input image into a plurality of tile images according to example embodiments;

FIG. 7 illustrates an example of an image hierarchy structure according to example embodiments;

FIG. 8 illustrates an example of an image hierarchy structure generated for a plurality of image channels according to example embodiments;

FIGS. 9A and 9B illustrate operations of estimating second motion information according to example embodiments;

FIG. 10 illustrates an example of searching for a block area of a target tile image that matches a block area of a reference tile image according to example embodiments;

FIGS. 11A and 11B illustrate operations of performing image processing on a target tile image according to example embodiments;

FIG. 12 illustrates an operation of performing image processing based on an image hierarchy structure according to example embodiments;

FIG. 13 is a flowchart illustrating a method for processing an image according to example embodiments; and

FIG. 14 is a flowchart illustrating a detailed operation of performing image processing on a target tile image according to example embodiments.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

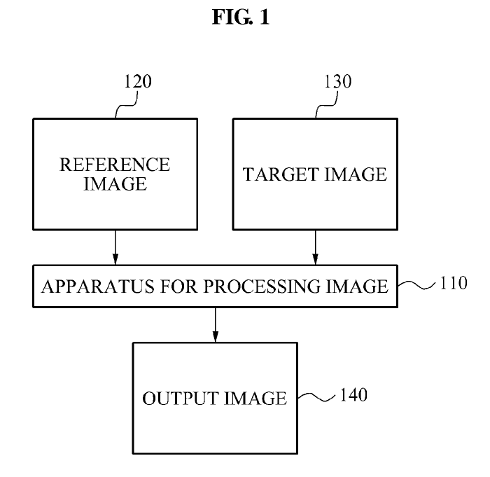

FIG. 1 illustrates an overall operation of an apparatus 110 for processing an image according to example embodiments.

An input image (hereinafter referred to as a reference image 120 and a target image 130) may refer to an image captured at predetermined intervals or simultaneously with respect to an identical object. That is, an input image may refer to a plurality of images taken of an identical subject that are captured at predetermined intervals or simultaneously. The plurality of images may be taken from a similar or different vantage point. The reference image 120 may refer to an image being used as a reference for processing the image in an image processing performed by the image processing apparatus 110, and the target image 130 may refer to an image being used as an object of the image processing. For example, the reference image 120 may be a first image captured from among a plurality of successive images captured with respect to an identical object. The target image 130 may be an image captured subsequent to the reference image 120, and may include at least one image. Distinguishing of the reference image 120 and the target image 130 may not be limited to the embodiments, and the apparatus 110 for processing the image may pre-determine the reference image 120 from among a plurality of images.

The apparatus 110 for processing the image may generate an output image 140 image processed through inputting the reference image 120 and the target image 130. When an object is captured using a short exposure time, the reference image 120 and the target image 130 may have an issue of image quality degradation due to motion of an image capturing apparatus such as a camera, and the like, or a motion of the object. The apparatus 110 for processing the image may generate a higher quality output image 140 by removing the image quality degradation issues. For example, the image processing apparatus 110 for may generate a high quality output image 140 by performing image processing, for example, enhancing a detail or a contrast.

The apparatus 110 for processing the image may estimate global motion information between input images, and may perform a tile image-based image processing based on the global motion information. The apparatus 110 for processing the image may estimate motion information with respect to the reference image 120 and the target image 130 as a whole, and perform the tile image-based image processing relatively more reliably by applying corresponding motion information to a process of processing a tile image. The apparatus 110 for processing the image may perform estimating of a motion relatively more precisely between tile images based on the global motion information when relatively few features of a tile image are present or a pattern of the tile image is absent.

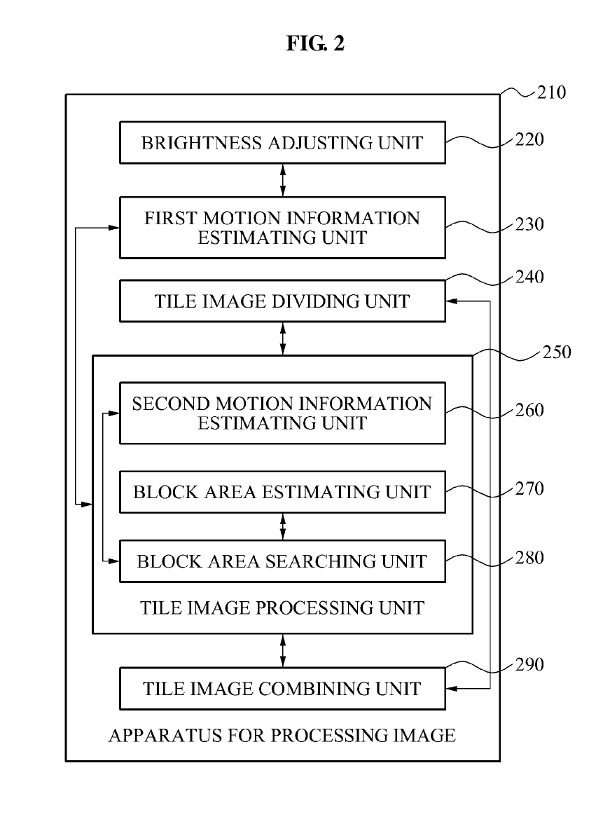

FIG. 2 illustrates a detailed configuration of an apparatus 210 for processing an image according to example embodiments.

Referring to FIG. 2, the apparatus 210 for processing the image may include, for example, a brightness adjusting unit 220, a first motion information estimating unit 230, a tile image dividing unit 240, a tile image processing unit 250, and a tile image combining unit 290. The tile image processing unit 250 may include a second motion information estimating unit 260, a block area dividing unit 270, and a block area searching unit 280.

A brightness of a reference image and a brightness of a target image may differ because the reference image and the target image have been captured using different exposure times. When the brightness of the reference image and the brightness of the target image differ, the brightness adjusting unit 220 may adjust the brightness of the target image to match the brightness of the reference image.

The brightness adjusting unit 220 may determine whether correcting the brightness of the target image is required based on exposure information of the reference image and the target image, or based on a brightness distribution variation between the reference image and the target image. When correcting of the brightness is determined to be required, the brightness adjusting unit 220 may adjust a brightness or perform a brightness correction on the target image so that a brightness distribution of the target image is similar to a brightness distribution of the reference image. For example, the brightness adjusting unit 220 may adjust the brightness of the target image using a brightness adjustment relationship between the reference image and the target image derived from a histogram matching.

The first motion information estimating unit 230 may estimate first motion information indicating a degree of motion of the target image with respect to the reference image. The first motion information may indicate a global motion present between the reference image and the target image. The first motion information estimating unit 230 may estimate a relative distance difference of the target image based on an image of the reference image as a whole.

More particularly, the first motion information estimating unit 230 may use a cumulative pixel value of the reference image and the target image in a horizontal direction and a vertical direction to estimate the first motion information. For example, the first motion information estimating unit 230 may generate a cumulative image one-dimensional (1D) curve in a horizontal direction and a vertical direction with respect to an input image, and estimate the first motion information using the cumulative image 1D curve. The cumulative image 1D curve may represent a cumulative pixel value in a horizontal direction and a vertical direction. For example, a curve value at a predetermined position on the cumulative image 1D curve in the horizontal direction may represent a cumulative value of pixel values included in a column at a corresponding position in the target image.

The first motion information estimating unit 230 may estimate the first motion information by matching the cumulative pixel value of the reference image and the cumulative pixel value of the target image in a horizontal direction and a vertical direction. The first motion information estimating unit 230 may compare patterns between the cumulative pixel value of the reference image in a horizontal direction and the cumulative pixel value of the target image in a horizontal direction, and compare patterns between the cumulative pixel value of the reference image in a vertical direction and the cumulative pixel value of the target image in a vertical direction to estimate the first motion information.

For example, the first motion information estimating unit 230 may set a search area based on the cumulative pixel value of the reference image in the horizontal direction, and identify a relative position at which a cross correlation between the cumulative pixel value of the reference image in the horizontal direction and the cumulative pixel value of the target image in the horizontal direction in the search area is at a maximum. The first motion information estimating unit 230 may estimate a motion of the target image in a horizontal direction using the relative position at which the cross correlation is at a maximum. The first motion information estimating unit 230 may estimate the motion of the target image for the vertical direction by repeating the above operation again with respect to the cumulative pixel value of the reference image in the vertical direction and the cumulative pixel value of the target image in the vertical direction. The first motion information estimating unit 230 may use various schemes including a normalized cross correlation (NCC) scheme, and the like, to estimate the cross correlation.

The first motion information estimating unit 230 may set a plurality of motion estimating areas for estimating the motion of the reference image and the target image to process an extended movement model as well as a translational movement. The first motion information estimating unit 230 may estimate the first motion information through matching the cumulative pixel value of the reference image and the cumulative pixel value of the target image in the horizontal direction and the vertical direction in the plurality of motion estimating areas set in the reference image and the target image. The first motion information estimating unit 230 may estimate a motion in a more complex movement model, for example, a rotation of the target image, by estimating a degree of translational movement in the plurality of motion estimating areas, and analyzing a result of the estimation.

The tile image dividing unit 240 may divide the reference image and the target image into a plurality of reference tile images and a plurality of target tile images. The tile image dividing unit 240 may divide the reference image into a plurality of reference tile images smaller than the reference image, and divide the target image into a plurality of target tile images smaller than the target image.

The tile image dividing unit 240 may set a size of the reference tile image for a plurality of adjacent reference tile image areas to overlap one another, and may divide the reference image based on the set size of the reference tile image. For example, the tile image dividing unit 240 may set the size of the target tile image for the plurality of target tile image areas to overlap one another, and may divide the target image based on the set size of the target tile image when dividing the target image into the target tile image.

The tile image processing unit 250 may perform image processing on the target tile image using the first motion information. More particularly, the tile image processing unit 250 may estimate a degree of motion for a plurality of target tile images, and perform the image processing on the target tile image, for example, removing noise, enhancing a detail, or enhancing a contrast. The tile image processing unit 250 may use the first motion information as basic information when estimating the degree of motion for the plurality of target tile images. For example, the tile image processing unit 250 may use the first motion information as an initial value for estimating the degree of motion for the plurality of target tile images.

The tile image processing unit 250 may apply a result of the image processing with respect to at least one of image channels configuring the reference tile image and the target tile image to an image processing of a remainder of the image channels. The tile image processing unit 250 may change motion information based on a relative size of the image channels configuring the reference tile image and the target tile image, and apply the changed motion information to another image channel.

For example, when the reference tile image and the target tile image are in a YCbCr444 form, the tile image processing unit 250 may apply the motion information derived from an image processing of a Y channel to an image processing of a Cb channel and a Cr channel. In this example, the tile image processing unit 250 may change the motion information derived from an image processing of the Y channel based on a size of an image of the Cb channel and the Cr channel, and apply the changed motion information to the image processing of the Cb channel and the Cr channel, when the reference tile image and the target tile image are in a YCbCr422 form.

The tile image processing unit 250 may perform the image processing on the target tile image based on an image hierarchy structure of the reference tile image and an image hierarchy structure of the target tile image. The tile image processing unit 250 may use an image hierarchy structure such as a Gaussian pyramid, a Laplacian pyramid, and the like. The tile image processing unit 250 may perform stable and rapid image processing as a series of image processing operations is performed based on the image hierarchy structure.

Hereinafter, for ease of description, the tile image processing unit 250 is assumed to use the Laplacian pyramid including a three-layer hierarchy structure. Here, the lower a level, the higher the frequency band component of the pyramid image. In particular, when the image hierarchy structure is the Laplacian image pyramid, a pyramid image of a highest level may have a low frequency band component. For example, when a size of the target tile image is (H×W), in the Laplacian pyramid, a size of an image in a “lowest level” is (H×W), a size of an image at an “intermediate level” is (H/2×W/2), and a size of an image of a “highest level” is (H/4×W/4).

The tile image processing unit 250 may perform image processing on the target tile image of a subsequent level of the image hierarchy structure of the target tile image, using a result of the image processing derived from a previous level. More particularly, the tile image processing unit 250 may perform a series of image processing operations from a highest level to a lowest level of the image hierarchy structure, and apply a result of the image processing at a corresponding level to an image processing of a subsequent lower level.

The tile image processing unit 250 may perform image processing on the target tile image of the highest level in the image hierarchy structure of the target tile image, using the first motion information because a previous level is absent for the highest level of the image hierarchy structure. For example, when a size of a motion included in the first motion information is represented by (a size of a motion in a row direction, a size of a motion in a column direction)=(Mx_i, My_i), a size of an image of the highest level may be ¼ of a size of the target tile image. Therefore, the tile image processing unit 250 may use a size of a motion corresponding to (Mx_i/4, My_i/4) as an initial value for estimating a motion.

The second motion information estimating unit 260 may estimate second motion information indicating a degree of motion of the target tile image with respect to the reference tile image using the first motion information. The second motion information estimating unit 260 may estimate the second motion information using a scheme similar to a scheme for estimating the first motion information conducted by the first motion information estimating unit 230.

More particularly, the second motion information estimating unit 260 may use a cumulative pixel value of the reference tile image and a cumulative pixel value of the target tile image in a horizontal direction and a vertical direction to estimate the second motion information. For example, the second motion information estimating unit 260 may generate a cumulative image 1D curve with respect to the reference tile image and the target tile image in a horizontal direction and a vertical direction, and may estimate the second motion information using the cumulative image 1D curve. The second motion information estimating unit 260 may estimate the second motion information using a relative position at which a cross correlation is at a maximum between the cumulative image 1D curve of the reference image and the cumulative image 1D curve of the target image in the horizontal direction and the vertical direction in a searching area.

However, the second motion information estimating unit 260 may set the search area based on the initial value for estimating the motion derived from the first motion information, unlike the first motion information estimating unit 230. For example, the second motion information estimating unit 260 may set a position on the target tile image to which the initial value for estimating the motion of (Mx_i/4, My_i/4) is applied to be a center position of the search area. The second motion information estimating unit 260 may reduce the search area in the target tile image and estimate a motion more precisely through use of the initial value for estimating the motion derived from the first motion information.

The block area dividing unit 270 may divide the reference tile image and the target tile image into a plurality of block areas to process a local motion in the reference tile image and the target tile image. The block area dividing unit 270 may divide the reference tile image into a plurality of block areas smaller than a size of the reference tile image, and divide the target tile image a plurality of block areas smaller than a size of the target tile image. For example, the block area dividing unit 270 may divide the reference tile image and the target tile image into a plurality of block areas of a size of “8×8”, “25×25”, and the like.

The block area searching unit 280 may search for a block area of the target tile image that matches a block area of the reference tile image using the second motion information. The block area searching unit 280 may search for a block area including a pattern of the target tile image that matches a pattern of the block area of the reference tile image. In this instance, the block area searching unit 280 may use third motion information indicating a degree of motion of the block area of the target tile image with respect to the block area of the reference tile image, as well as the second motion information.

For example, the block area searching unit 280 may set a search area in the target tile image based on a result of calculating a sum a size of a motion included in the second motion information and a size of a motion included in the third motion information. The block area searching unit 280 may search for a matching block area in a limited search area by setting a position on the target tile image to which the calculated sum is applied as a center position.

The block area searching unit 280 may use various image block-based similarity discriminators, for example, sum of squared difference (SSD), sum of absolute difference (SAD), and the like, to search for a matching block area. The block area searching unit 280 may determine a position at which a similarity is maximized or minimized using a similarity discriminator. The block area searching unit 280 may use a fixed or variable threshold value to determine whether the matching block area is present due to occlusion or un-occlusion between the reference tile image and the target tile image. More particularly, the block area searching unit 280 may determine whether the matching block area is present by comparing the threshold value and a value of the similarity discriminator.

Upon completion of the target tile image being searched, a block area that matches a number of target images that are input with respect to a plurality of block areas of the reference tile image may be found. In this instance, irrespective of the number of target images input, a block area may be found when the block area searching unit 280 uses the threshold value and the similarity discriminator. For example, when the block area searching unit 280 identifies a matching block area in a case of a similarity value being greater than the threshold value, a plurality of matching block areas may be present in a single target image or a matching block area may be absent.

The tile image processing unit 250 may perform image processing on the target tile image using a pixel value of the block area of the reference tile image and pixel values of a plurality of blocks areas found in the target tile image. The tile image processing unit 250 may perform image processing such as removing noise, enhancing a detail or a contrast, and the like, using pixel values of a plurality of block areas matching between the reference tile image and the target tile image. For example, the tile image processing unit 250 may remove noise of an image by calculating an average of the pixel values of the plurality of block areas matching between the reference tile image and the target tile image.

The tile image processing unit 250 may apply a result of the image processing to the plurality of block areas matching the reference tile image and the target tile image so as to apply the result of the image processing to a current level of the image hierarchy structure. In this instance, the tile image processing unit 250 may correct an image using a weighted memory map and a weighted image memory map to remove image quality degradation occurring at a boundary between block areas.

The tile image processing unit 250 may perform a motion estimating and an image processing in a unit of a block area until all block areas in each of the reference tile image and the target tile image have been image processed. The tile image processing unit 250 may determine whether a current level is a lowest level by verifying a level of the image hierarchy structure when the motion estimating and the image processing are performed with respect to the total of block areas.

The tile image processing unit 250 may perform the image processing as described above with respect to another reference tile image when a current level is a lowest level by verifying a level of the image hierarchy structure.

When a current level is verified as not being the lowest level subsequent to the verifying of the level of the image hierarchy structure, the tile image processing unit 250 may lower a single level of the image hierarchy structure, and apply a result of the image processing performed in a previous level to the current level. For example, the tile image processing unit 250 may apply the second motion information, the third motion information, and resulting images obtained through the image processing to a current level, and use the result of the applying as an initial value for estimating a motion at the current level or as an input image for a subsequent image processing. The tile image processing unit 250 may perform up-scaling on an image in order for a size of an image resulting from a previous level to be identical to a size of an image of a current level so as to apply the image processed image resulting from the previous level to the current level. For example, when based on the image hierarchy structure, a width and a height of a resulting image may increase by a factor of two, subsequent to the up-scaling. The tile image processing unit 250 may generate an input image of a low frequency band at the current level by applying the up-scaled image resulting from the previous level, being a low frequency band image, to a pyramid image at the current level. The tile image processing unit 250 may re-perform a series of the motion estimating and the image processing, and output an image resulting from the current level by inputting the low frequency band image generated. To use as an initial value for estimating motion information of the current level, the tile image processing unit 250 may increase a size of the motion information derived from the previous level by a factor of two.

The tile image processing unit 250 may estimate motion information and perform a series of image processing operations on a total of reference tile images and target tile images based on the image hierarchy structure.

The tile image combining unit 290 may combine the image processed target tile images. The tile image combining unit 290 may generate a single output image by combining the image processed target tile images. The tile image combining unit 290 may remove image quality degradation at a boundary between the target tile images by blending an overlapping area of the target tile images. For example, the tile image combining unit 290 may perform the blending at the boundary using the weighted memory map and the weighted image memory map.

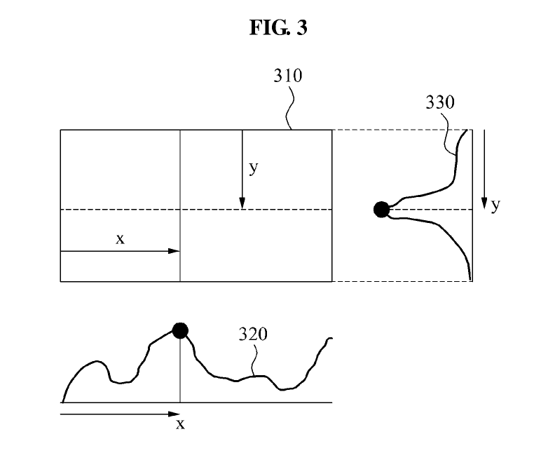

FIG. 3 illustrates an example of generating a cumulative image 1D curve according to example embodiments.

Referring to FIG. 3, an example in which an apparatus for processing an image generates the cumulative image 1D curve to estimate first motion information is illustrated. The apparatus for processing the image may generate the cumulative image 1D curve using the same scheme for both a reference image and a target image. FIG. 3 illustrates a process of generating the cumulative image 1D curve of a target image 310.

The apparatus for processing the image may calculate a sum of a pixel value of a total of image pixels located at a predetermined column as the apparatus for processing the image moves in a horizontal direction, that is an x direction, of the target image 310. The apparatus for processing the image may generate the cumulative image 1D curve 320 in the horizontal direction by representing the calculated sum as a height value on a 1D curve.

The apparatus for processing the image may calculate a sum of the pixel value of the total of image pixels located at a predetermined row as the apparatus for processing the image moves in a vertical direction, being a y direction, of the target image 310. The apparatus for processing the image may generate a cumulative image 1D curve 330 in the vertical direction by representing the calculated sum as a height value on the 1D curve.

The cumulative image 1D curves 320 and 330 in the horizontal and vertical directions generated through the process above may represent a cumulative pixel value in a horizontal direction and a vertical direction. For example, in the cumulative image 1D curve 320 in the horizontal direction, a curve value at a predetermined position may represent a cumulative value of pixel values included in a column at a corresponding position in the target image 310.

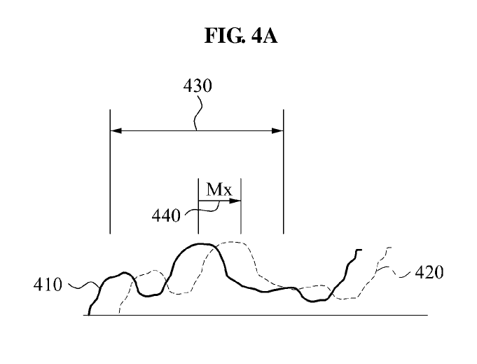

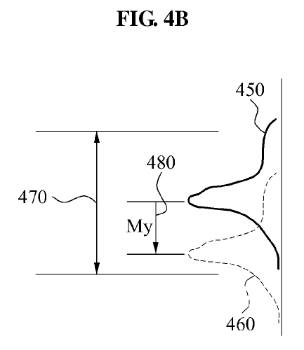

FIGS. 4A and 4B illustrate examples of estimating first motion information according to example embodiments.

Referring to FIGS. 4A and 4B, examples in which an apparatus for processing an image estimates first motion information by comparing patterns between a cumulative image 1D curve in a horizontal direction and a cumulative image ID curve in a vertical direction are illustrated. FIG. 4A illustrates a cumulative image 1D curve 410 of a reference image and a cumulative image 1D curve 420 of a target image in a horizontal direction. The apparatus for processing the image may set a predetermined search area 430, centered around the cumulative image 1D curve 410 of the reference image. For example, the apparatus for processing the image may set the searching area 430 centered around a maximum point, a minimum point, an inflection point, and the like, among the cumulative image 1D curve 410 of the reference image. The apparatus for processing the image may identify a relative position at which a cross correlation between the cumulative image 1D curve 410 of the reference image and the cumulative image 1D curve 420 of the target image in a section of the searching area 320 is at a maximum. The cumulative image 1D curve 410 of the reference image and the cumulative image 1D curve 420 of the target image may have a maximum similarity at the relative position identified. The apparatus for processing the image may estimate a motion 440 with respect to a horizontal direction based on the relative position at which the cross correlation is at a maximum.

In FIG. 4B, the apparatus for processing the image may set a search area 470 with respect to a cumulative image 1D curve 450 of the reference image and a cumulative image 1D curve 460 of the target image in a vertical direction, and estimate a motion 480 with respect to the vertical direction through the same process performed in FIG. 4A.

When a global motion between the reference image and the target image is a translation movement, the apparatus for processing the image may estimate first motion information based on the motion 440 in the horizontal direction and the motion 480 in the vertical direction.

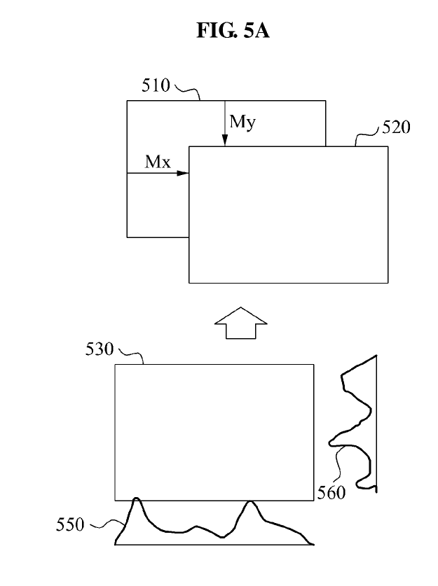

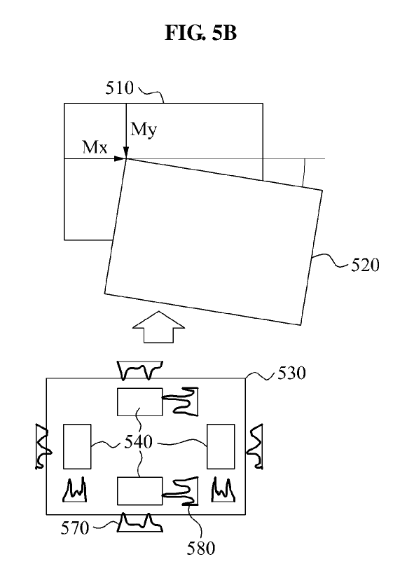

FIGS. 5A and 5B illustrate operations of estimating first motion information with respect to a translational movement and a rotational movement according to example embodiments.

Referring to FIGS. 5A and 5B, examples in which an apparatus for processing an image estimates the first motion information in an extended movement model as well as the translational movement are illustrated. FIG. 5A illustrates an example in which a global motion between a reference image and a target image is a simple translational movement, and FIG. 5B illustrates an example in which a rotational movement is combined with the translational movement.

In FIG. 5A, the apparatus for processing the image may estimate a motion with respect to the translational movement between the reference image 510 and the target image 520 using a cumulative image 1D curve 550 in a horizontal direction and a cumulative image 1D curve 560 in a vertical direction of an input image 530.

FIG. 5B illustrates an example in which rotational movement exists as well as the translational movement between the reference image 510 and the target image 520. Here, the apparatus for processing the image may estimate a motion based on a plurality of motion estimation areas 540 set for an input image 530. The apparatus for processing the image may estimate a degree of motion of the translational movement using a cumulative image 1D curve 570 in a horizontal direction and a cumulative image 1D curve 580 in a vertical direction in a plurality of motion estimation areas 540. The apparatus for processing the image may estimate a motion in a more complex movement model as well as the translational movement by analyzing the degree of motion of the translational movement estimated in the plurality of motion estimation areas 540.

For example, when the plurality of motion estimation areas 540 is set on an upper, lower, right, and left portion of the input image 530, the apparatus for processing the image may estimate a degree of motion of the target image 520 at a position of the plurality of motion estimation areas 540, compared to the reference image 510. The apparatus for processing the image may estimate the rotational movement of the target image 520 by analyzing a degree of motion in the plurality of motion estimation areas 540.

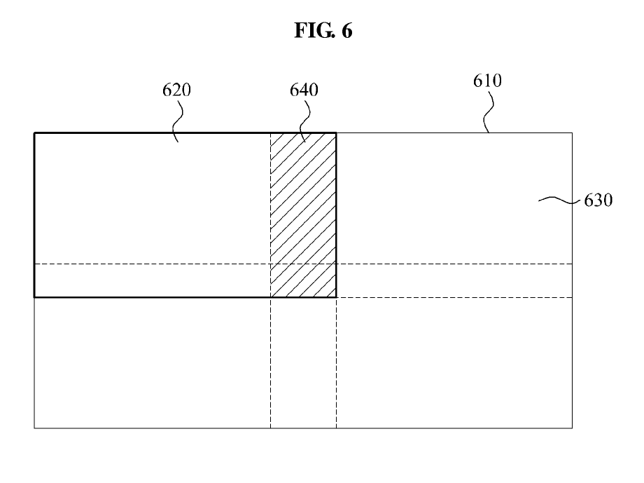

FIG. 6 illustrates an example in which an apparatus for processing an image divides an input image 610 into four tile images. In particular, when the input image 610 is a reference image, the input image 610 may be divided into reference tile images, and when the input image 610 is a target image, the input image 610 may be divided into target tile images.

The apparatus for processing the image may set a size of the tile image for an area of tile images to overlap one another, and may divide the input image 610 based on the set size of the tile image. In this instance, as shown in FIG. 6, an overlapping area 640 between a first tile image 620 and a second tile image may be present. The apparatus for processing the image may prevent an occurrence of image quality degradation by performing a blending on the overlapping area 640 when image processed tile images are combined subsequently.

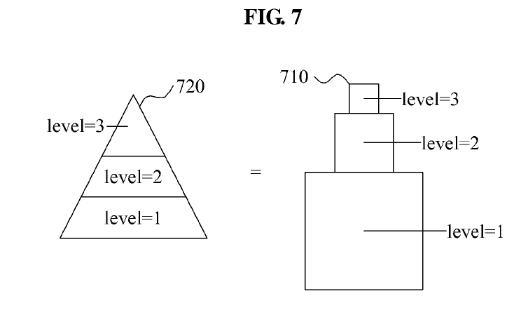

FIG. 7 illustrates an example of an image hierarchy structure according to example embodiments.

Referring to FIG. 7, a right image 710 illustrates an image hierarchy structure including a three-layer hierarchy structure, and a left image 720 illustrates an image hierarchy structure in the form of a diagram. In FIG. 7, it is assumed that the right image 710 is a Laplacian image pyramid, and a size of a reference tile image and a target tile image is represented by (width W, height H)=(W×H) for ease of description.

When the image hierarchy structure is the Laplacian image pyramid, a pyramid image of a highest level, being a level=3, may have a low frequency component. In particular, the lower a level of the pyramid image, the higher the frequency band component. Accordingly, a lowest level, being a level=1, may have a highest frequency band component. When a size of a target tile image is (W×H), a size of an image at “level=1” may be (W×H), a size of an image at “level=2” may be (W/2×H/2), and a size of an image at “level=3” may be (W/4×H/4), as an example.

The apparatus for processing the image may perform a series of image processing operations from a highest level to a lowest level of the image hierarchy structure, and a result of the image processing at a corresponding level may be applied to an image processing of a subsequent lower level.

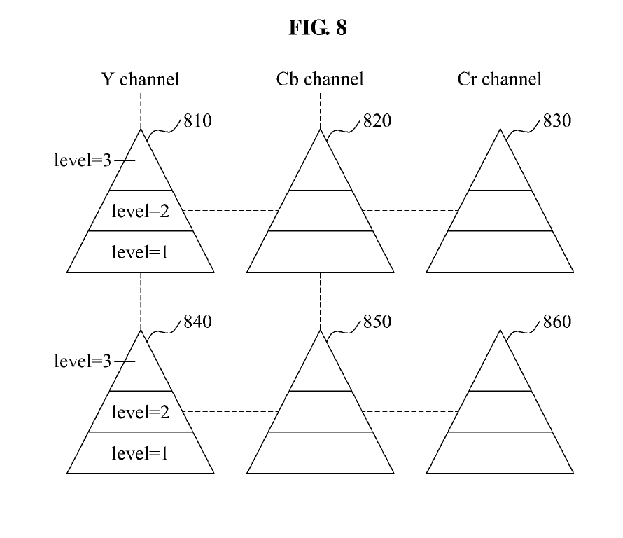

FIG. 8 illustrates an example of image hierarchy structures 810, 820, 830, 840, 850, and 860 generated for a plurality of image channels according to example embodiments.

Referring to FIG. 8, the image hierarchy structures 810, 820, 830, 840, 850, and 860 including a three-layer hierarchy structure are illustrated in the form of a diagram. The apparatus for processing the image may generate the image hierarchy structures 810, 820, 830, 840, 850, and 860 for the plurality of image channels configuring a reference tile image and a target tile image. For example, when the reference tile image and the target tile image have a color space of YCbCr, the apparatus for processing the image may use the image hierarchy structure configured for the plurality of image channels of the reference tile image and the target tile image. The reference tile image may have the image hierarchy structure 810 of a Y channel, the image hierarchy structure 820 of a Cb channel, and the image hierarchy structure 830 of a Cr channel. The target tile image may also have the image hierarchy structure 840 of a Y channel, the image hierarchy structure 850 of a Cb channel, and the image hierarchy structure 860 of a Cr channel.

The apparatus for processing the image may apply a result of the image processing with respect to at least one image channel to a remainder of the image channels. For example, the apparatus for processing the image may apply a result of the image processing in the image hierarchy structures 810 and 840 of the Y channel to an image processing in the image hierarchy structures 820 and 850 of the Cb channel.

When the reference tile image and the target tile image are in a YCbCr444 format, the apparatus for processing the image may apply an entire size of a motion derived from the image processing of the Y channel to the image processing of the Cb channel and the Cr channel. When the reference tile image and the target tile image are in a YCbCr422 format, the apparatus for processing the image may adjust the size of the motion derived from the image processing of the Y channel to apply the adjusted size of the motion to the image processing of the Cb channel and the Cr channel. For example, when a size of an image of a luminance channel, in this example, a Y channel, is (width W, height H), and a size of an image of a chroma channel, in this example, a Cr channel and a Cr channel, is (width W, height H/2), the apparatus for processing the image may apply the entire size of the motion in a row direction derived from the image processing of the luminance channel to the chroma channel, and apply the size of the motion in a column direction to the chroma channel through being reducing by a factor of two.

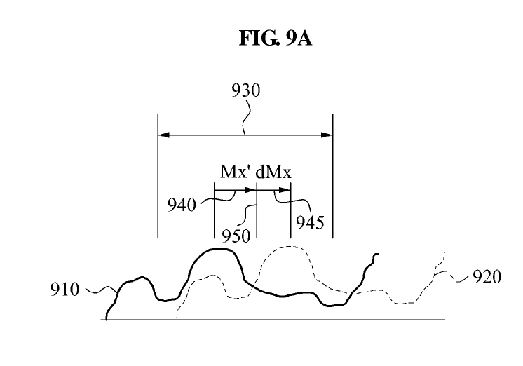

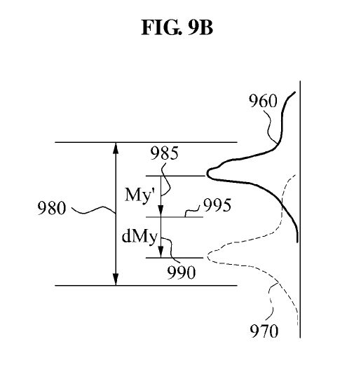

FIGS. 9A and 9B illustrate operations of estimating second motion information according to example embodiments.

Referring to FIGS. 9A and 9B, examples in which an apparatus for processing an image compares patterns of a cumulative image 1D curve in a horizontal direction and a vertical direction in a reference tile image and a target tile image to estimate the second motion information are illustrated.

FIG. 9A illustrates the cumulative image 1D curve 910 of the reference tile image in the horizontal direction and the cumulative image 1D curve 920 of the target tile image in the vertical direction. The apparatus for processing the image may set a predetermined search area 930 centered around the cumulative image 1D curve 910 of the reference tile image. In this instance, the apparatus for processing the image may set the search area 930 based on an initial value for estimating a motion derived from first motion information. For example, when the apparatus for processing the image estimates a motion in a horizontal direction, a center position 950 of the searching area 930 may be set based on the initial value for estimating the motion Mx′ 940 derived from the first motion information. The apparatus for processing the image may estimate a size of a motion dMx 945 in a horizontal direction using a relative position at which a cross correlation is at a maximum between the cumulative image 1D curve 910 of the reference tile image and the cumulative image 1D curve 920 of the target tile image in the searching area 930.

In FIG. 9B, the apparatus for processing the image may set a search area 980 based on an initial value for estimating a motion My′ 985 derived from the first motion information with respect to a cumulative image 1D curve 960 of the reference tile image and a cumulative image 1D curve 970 of the target tile image in a vertical direction, and estimate a size of a motion dMy 990 in a vertical direction, through the same process as performed in FIG. 9A. In this instance, the apparatus for processing the image may set a center position 995 of the searching area 980 based on the initial value for estimating the motion My′ 985 derived from the first motion information.

The apparatus for processing the image may estimate the second motion information based on the initial values for estimating the motion Mx′ 940 and My′ 985 derived from the first motion information, the size of the motion in the horizontal direction dMx 945, and the size of the motion dMy 990 in the vertical direction. For example, the size of the motion included in the second motion information may be represented by (MX=Mx′+dMx, MY=My′+dMy).

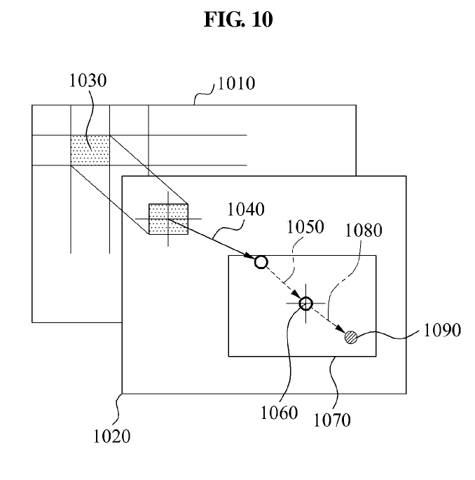

FIG. 10 illustrates an example of searching for a block area of a target tile image 1020 that matches a block area 1030 of a reference tile image 1010 according to example embodiments.

An apparatus for processing an image may search for the block area of the target tile image 1020 that matches the block area 1030 divided in the reference tile image 1010. The apparatus for processing the image may set a center position 1060 of a searching area 1070, based on a size of a motion 1040 included in second motion information, and an initial value for estimating a motion 1050 of third motion information in a predetermined block area. The initial value for estimating the motion 1050 of the third motion information may be based on a result of image processing for a plurality of image hierarchy structures. The apparatus for processing the image may calculate a displacement 1080 from the center position 1060 by identifying a position 1090 at which a similarity is at a maximum in the searching area 1070. Accordingly, the newly estimated third motion information may be determined based on the initial value for estimating the motion 1050 of the third motion information and the displacement 1080.

For example, when the initial value for estimating a motion 1050 of the third motion information is (Lx′, Ly′), and the displacement 1080 from the center position 1060 is (dLx, dLy), the newly estimated third motion information (Lx, Ly) may correspond to (Lx′+dLx, Ly′+dLy).

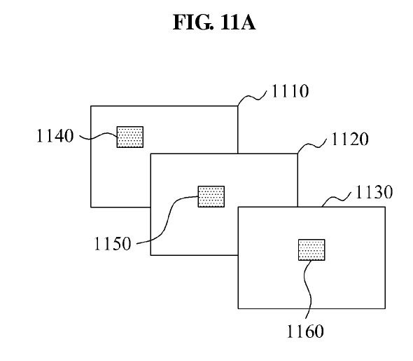

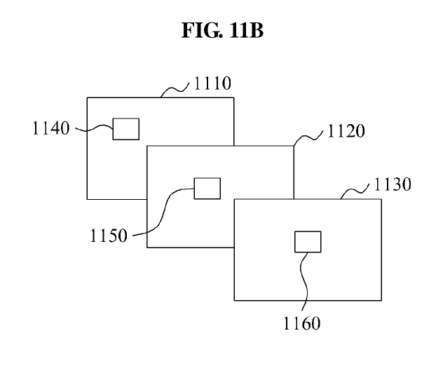

FIGS. 11A and 11B illustrate operations of performing an image processing on a plurality of target tile images 1120 and 1130 according to example embodiments.

FIG. 11A illustrates a reference tile image 1110 and the plurality of target tile images 1120 and 1130. FIG. 11A also illustrates block areas 1150 and 1160 of the plurality of target tile images 1120 and 1130 that match a predetermined block area 1140 of the reference tile image 1110. An apparatus for processing an image may perform image processing such as removing noise, enhancing a detail or a contrast, and the like, using pixel values of the block areas 1140, 1150, and 1160 that match the reference tile image 1110 and the plurality of target tile images 1120 and 1130. For example, the apparatus for processing the image may remove noise of an image by calculating an average of the pixel values of the blocks areas 1140, 1150, and 1160 that match the reference tile image 1110 and the plurality of target tile images 1120 and 1130.

In FIG. 11B, the apparatus for processing the image may apply a result of the image processing to a current level of an image hierarchy structure by applying the result of the image processing to the block areas 1140, 1150, and 1160 that match the reference tile image 1110 and the plurality of target tile images 1120 and 1130. In this instance, the apparatus for processing the image may correct an image using a weighted memory map and a weighted image memory map to remove image quality degradation occurring at a boundary between the block areas 1140, 1150, and 1160.

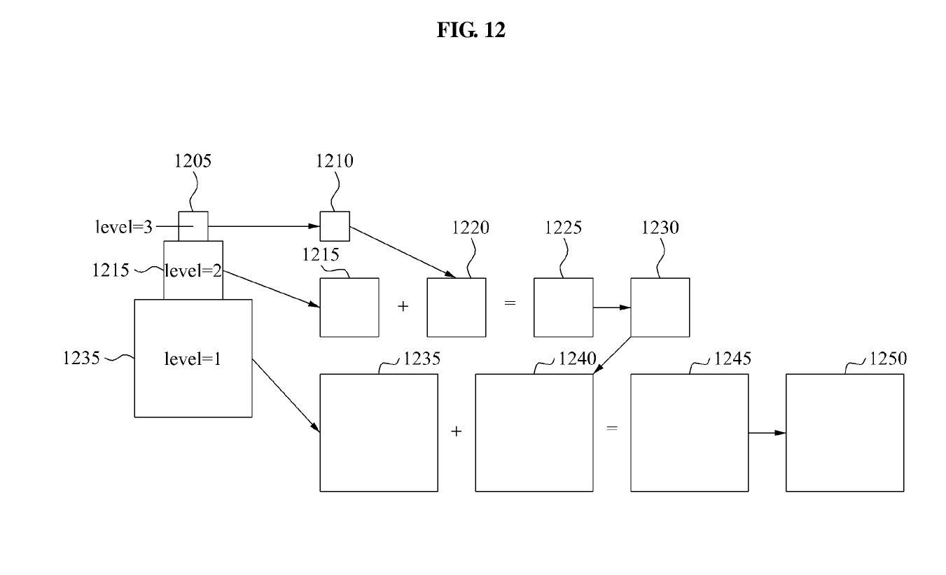

FIG. 12 illustrates an operation of performing an image processing based on an image hierarchy structure according to example embodiments.

An apparatus for processing an image may generate a resulting image 1210, for example a low frequency band image, by estimating a motion of a reference tile image with respect to an image 1205, for example a low frequency band image, of a highest level, for example a level=3, in the image hierarchy structure and performing image processing, and may apply the resulting image 1210 to a current level. The apparatus for processing the image may generate an output image 1220, of which a size is up-scaled, to apply the resulting image 1210 generated at the highest level to a subsequent level.

The apparatus for processing the image may generate a new input image 1225, for example a low frequency band image, by applying the output image 1220 up-scaled at the highest level to an image 1215, for example a high frequency band image, of an intermediate level, for example a level=2. Motion estimation information and a result of the image processing of the resulting image 1210 of the highest level may be applied to the new input image 1225 generated at the intermediate level. As an example, when the image hierarchy structure is a Laplacian pyramid, a size of an image at the intermediate level may be greater than a size of an image at the highest level, by a factor of two. Accordingly, the apparatus for processing the image may use an estimated motion value estimated at the highest level by up-scaling the estimated motion value by twice as an initial value for estimating a motion at the intermediate level. The apparatus for processing the image may generate a resulting image 1230, being a low frequency band image, by estimating a motion of the reference tile image and performing an image processing with respect to the new input image 1225, as performed at the highest level. The apparatus for processing the image may generate an output image 1240, being a low frequency band image, of which a size of an image is up-scaled, to apply the resulting image 1230 to the intermediate level, being a current level, and apply the generated resulting image 1230 to a subsequent level.

The apparatus for processing the image may generate a new input image 1245, for example a low frequency band image, by applying the up-scaled output image 1240 at the intermediate level to an image 1235, for example a high frequency band image, at a lowest level, for example a level=1. Motion estimation information and a result of the image processing of the resulting image 1230 at the intermediate level may be applied to the new input image 1245 generated at the lowest level. As an example, when the image hierarchy structure is a Laplacian pyramid, a size of an image at the lowest level may be greater than a size of an image at the intermediate level, by a factor of two. Accordingly, the apparatus for processing the image may use an estimated motion value estimated at the intermediate level by up-scaling the estimated motion value by twice as an initial value for estimating a motion at the lowest level. The apparatus for processing the image may generate a resulting image 1250, for example a low frequency band image, by estimating a motion of the reference tile image and performing an image processing with respect to the new input image 1245, as performed at the intermediate level. The resulting image 1250 generated through the above process may be a final resulting image with respect to a single target tile image. The apparatus for processing the image may repeat the above process with respect to a subsequent target tile image when the final resulting image with respect to the single target tile image is generated.

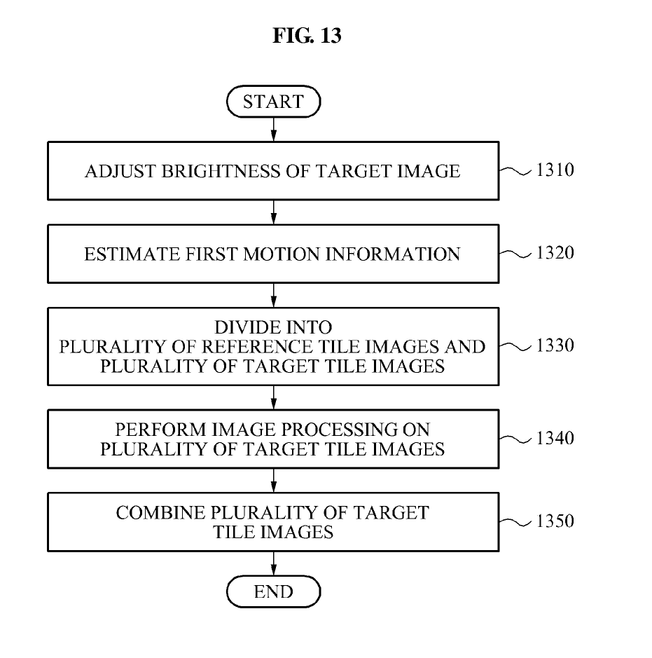

FIG. 13 is a flowchart illustrating a method for processing an image according to example embodiments.

In operation 1310, an apparatus for processing an image may adjust a brightness of a target image to match the brightness of the target image to a brightness of a reference image when the brightness of the reference image and the brightness of the target image differ. When a correction of the brightness of the target image is determined to be desirable or necessary, the apparatus for processing the image may adjust the brightness or perform a brightness correction on the target image for a brightness distribution of the target image to be similar to a brightness distribution of the reference image. For example, the apparatus for processing the image may adjust the brightness of the target image using a brightness adjustment relationship between the reference image and the target image derived from a histogram matching.

In operation 1320, the apparatus for processing the image may estimate first motion information indicating a degree of motion of the target image with respect to the reference image. More particularly, the apparatus for processing the image may use a cumulative pixel value of the reference image and the target image in a horizontal direction and a vertical direction to estimate the first motion information. For example, the apparatus for processing the image may generate a cumulative image 1D curve in a horizontal direction and a cumulative image 1D curve in a vertical direction with respect to an input image, and estimate the first motion information using the cumulative image 1D curve. The cumulative image 1D curve may represent the cumulative pixel value in the horizontal direction and the cumulative pixel value in the vertical direction.

The apparatus for processing the image may estimate the first motion information by matching the cumulative pixel value of the reference image and the cumulative pixel value of the target image in the horizontal direction and the vertical direction. The apparatus for processing the image may compare a pattern of the cumulative pixel value of the reference image and a pattern of the cumulative pixel value of the target image in the horizontal direction, and estimate the first motion information by comparing the pattern of the cumulative pixel value of the reference image and the pattern of the cumulative pixel value of the target image in the vertical direction.

For example, the apparatus for processing the image may set a searching area based on the cumulative pixel value of the reference image in the horizontal direction, and identify a relative position at which a cross correlation between the cumulative pixel value of the reference image in the horizontal direction and the cumulative pixel value of the target image in the horizontal direction in the searching area is at a maximum. The apparatus for processing the image may estimate a motion of the target image in the horizontal direction using the relative position at which the cross correlation is at a maximum.

The apparatus for processing the image may set a plurality of motion estimation areas to estimate a motion of the reference image and the target image to process an extended movement model as well as a translational movement. The apparatus for processing the image may estimate the first motion information through matching the cumulative pixel value of the reference image and the cumulative pixel value of the target image in the horizontal direction and the vertical direction from among the plurality of motion estimation areas set for the reference image and the target image.

In operation 1330, the apparatus for processing the image may divide the reference image and the target image into a plurality of reference tile images and a plurality of target tile images, respectively. The apparatus for processing the image may set a size of the plurality of reference tile images for a plurality of adjacent reference tile image areas to overlap one another, and divide the reference image based on the set size of the plurality of reference tile images.

In operation 1340, the apparatus for processing the image may perform image processing on the target tile image using the first motion information. More particularly, the apparatus for processing the image may estimate a degree of motion for a plurality of target tile images, and based on the estimated degree of motion, perform image processing such as removing noise, enhancing detail or contrast, and the like, on the plurality of target tile images.

The apparatus for processing the image may apply a result of the image processing with respect to at least one of image channels configuring the reference tile image and the target tile image to an image processing of a remainder of the image channels. For example, the apparatus for processing the image may adjust a size of a motion based on a relative size of an image of the image channels configuring the reference tile image and the target tile image, and may apply the adjusted size of the motion to another image channel.

The apparatus for processing the image may perform image processing on the target tile image based on the image hierarchy structure of the reference tile image and the image hierarchy structure of the target tile image. The apparatus for processing the image may use the image hierarchy structure, for example, a Gaussian pyramid, a Laplacian pyramid, and the like.

The apparatus for processing the image may perform image processing on the target tile image of a highest level in the image hierarchy structure of the target tile image using the first motion information because a previous level is absent in a highest level of the image hierarchy structure.

The apparatus for processing the image may perform image processing on the target tile image of a subsequent level in the image hierarchy structure of the target tile image using a result of the image processing derived from a previous level. The apparatus for processing the image may lower a single level of the image hierarchy structure when a current level fails to be a lowest level by verifying a level of the image hierarchy structure, and may apply a result of the image processing performed in the previous level to the current level. For example, the apparatus for processing the image may apply second motion information, third motion information resulting from the image processing performed in the previous level, and resulting images obtained through the image processing to the current level, and the result of applying as an initial value for estimating a motion at the current level or as an input image for a subsequent image processing. An image resulting from the above process may be a final resulting image with respect to a single target tile image.

The apparatus for processing the image may repeat the above process with respect to a subsequent target tile image when the final resulting image is generated with respect to the single target tile image.

In operation 1350, the apparatus for processing the image may combine the image processed plurality of target tile images. The apparatus for processing the image may generate a single output image by combing the image processed plurality of target tile images, and remove image quality degradation at a boundary between the plurality of target tile images by blending an overlapping area between the plurality of target tile images.

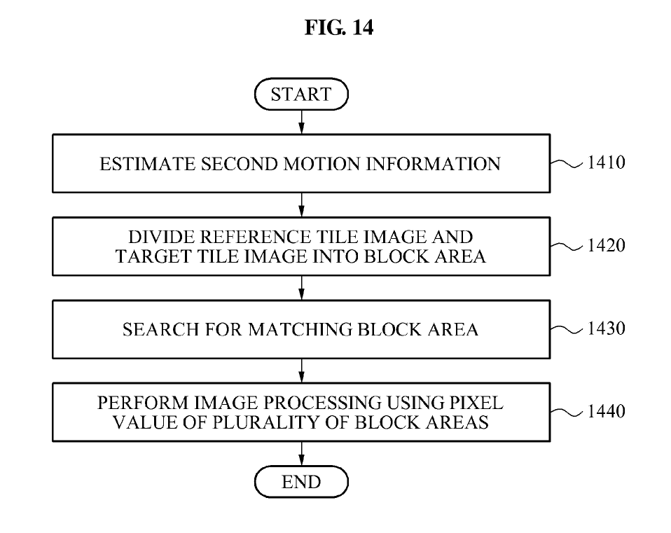

FIG. 14 is a flowchart illustrating a detailed operation of performing image processing on a target tile image according to example embodiments.

In operation 1410, an apparatus for processing an image may estimate second motion information indicating a degree of motion of a target tile image with respect to a reference tile image. The apparatus for processing the image may estimate the second motion information, using a scheme similar to a scheme performed to estimate the first motion information. For example, the apparatus for processing the image may use a cumulative pixel value of a reference tile image and a cumulative pixel value of a target tile image in a horizontal direction and a vertical direction to estimate the second motion information. However, the apparatus for processing the image may set a search area for estimating the second motion information based on an initial value for estimating a motion derived from the first motion information, unlike a process of estimating the first motion information.

In operation 1420, the apparatus for processing the image may divide the reference tile image and the target tile image into a plurality of block areas. The apparatus for processing the image may divide the reference tile image into a plurality of block areas, of which a size is smaller than a size of the reference tile image, and may divide the target tile image into a plurality of block areas of which a size is smaller than a size of the target tile image.

In operation 1430, the apparatus for processing the image may search for a block area of the target tile image that matches a block area of the reference tile image using the second motion information. The apparatus for processing the image may search for a block area including a pattern that matches a pattern of the block area of the reference tile image. In this instance, the apparatus for processing the image may use third motion information indicating a degree of motion of the block area of the target tile image with respect to the block area of the reference tile image as well as the second motion information.

In operation 1440, the apparatus for processing the image may perform image processing on the target tile image using a pixel value of the block area of the reference tile image and a pixel value of the block area found in the target tile image. The apparatus for processing the image may perform image processing such as removing noise, enhancing a detail or a contrast, and the like, using a pixel value of a plurality of block areas that matches between the reference tile image and the target tile image. For example, the apparatus for processing the image may remove noise of an image by calculating an average of pixel values of the block areas that match between the reference tile image and the target tile image.

In one or more embodiments of the present disclosure, the apparatus for processing the image may be disposed within, connected to, or wirelessly communicating with a portable device. A portable device as used throughout the present specification includes mobile communication devices, such as a personal digital cellular (PDC) phone, a personal communication service (PCS) phone, a personal handy-phone system (PHS) phone, a Code Division Multiple Access (CDMA)-2000 (1X, 3X) phone, a Wideband CDMA phone, a dual band/dual mode phone, a Global System for Mobile Communications (GSM) phone, a mobile broadband system (MBS) phone, a satellite/terrestrial Digital Multimedia Broadcasting (DMB) phone, a Smart phone, a cellular phone, a personal digital assistant (PDA), an MP3 player, a portable media player (PMP), an automotive navigation system (for example, a global positioning system), and the like. Also, the portable device as used throughout the present specification includes a digital camera, a plasma display panel, and the like.

The method for processing the image according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like.

Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa. Any one or more of the software modules described herein may be executed by a controller such as a dedicated processor unique to that unit or by a processor common to one or more of the modules. The described methods may be executed on a general purpose computer or processor or may be executed on a particular machine such as the apparatus for processing an image described herein.

Although embodiments have been shown and described, it would be appreciated by those skilled in the art that changes may be made in these embodiments without departing from the principles and spirit of the disclosure, the scope of which is defined by the claims and their equivalents.

What is claimed is:

1. A method for processing an image, the method comprising:
estimating, by way of a processor, first motion information indicating a degree of motion of a target image with respect to a reference image;
dividing the reference image and the target image, respectively, into a plurality of reference tile images and a plurality of target tile images;
performing image processing on the plurality of target tile images using the first motion information; and
combining the image-processed target tile images.

2. The method of claim 1, wherein the estimating comprises:
estimating the first motion information using a cumulative pixel value of the reference image and a cumulative pixel value of the target image in a horizontal direction and a vertical direction.

3. The method of claim 2, wherein the estimating comprises:
estimating the first motion information by matching the cumulative pixel value of the reference image and the cumulative pixel value of the target image in the horizontal direction and the vertical direction.

4. The method of claim 2, wherein the estimating comprises:
estimating the first motion information using a relative position at which a cross correlation between the cumulative pixel value of the reference image and the cumulative pixel value of the target image are at a maximum.

5. The method of claim 2, wherein the estimating comprises:
estimating the first motion information by matching the cumulative pixel value of the reference image and the cumulative pixel value of the target image for the horizontal direction and the vertical direction in a plurality of motion estimation areas set for the reference image and the target image.

6. The method of claim 1, wherein the performing of the image processing comprises:
applying a result of the image processing with respect to at least one of image channels configuring a reference tile image or a target tile image to an image processing performed on a remainder of the image channels.

7. The method of claim 1, wherein the performing of the image processing comprises:
performing the image processing on a target tile image, of the plurality of target tiles images, based on an image hierarchy structure of a reference tile image and an image hierarchy structure of the target tile image.

8. The method of claim 7, wherein the performing of the image processing comprises:
performing the image processing on a target tile image of a highest level in the image hierarchy structure of the target tile image using the first motion information.

9. The method of claim 7, wherein the performing of the image processing comprises:
performing the image processing on a target tile image of a subsequent level in the image hierarchy structure of the target tile image using a result of image processing derived from a previous level.

10. The method of claim 7, wherein the performing of the image processing comprises:
estimating second motion information indicating a degree of motion of the target tile image with respect to the reference tile image using the first motion information;
dividing the reference tile image and the target tile image into a plurality of block areas;
searching for a block area of the target tile image that matches a block area of the reference tile image using the second motion information; and
performing the image processing on the target tile image using a pixel value of the block area found in the reference tile image and a pixel value of the block area found in the target tile image.

11. The method of claim 10, wherein the searching comprises:
searching for a block area including a pattern that matches a pattern of the block area of the reference tile image in a searching area set based on the second motion information.

12. The method of claim 1, further comprising:
adjusting a brightness of the target image mage to match a brightness of the reference image,
wherein the dividing comprises:
dividing, into the plurality of reference tile images and the plurality of target tile images, the reference image and the target image for which the brightness has been adjusted.

13. The method of claim 12, wherein the adjusting of the brightness comprises:
adjusting the brightness of the target image using a brightness adjustment relationship between the reference image and the target image derived from a histogram matching.

14. An apparatus for processing an image, the apparatus comprising:
a processor to control one or more processor-controllable units;
a first motion information estimating unit to estimate first motion information indicating a degree of motion of a target image with respect to a reference image;
a tile image dividing unit to divide the reference image and the target image, respectively, into a plurality of reference tile images and a plurality of target tile images;
a tile image processing unit to perform image processing on the plurality of target tile images using the first motion information; and
a tile image combining unit to combine the plurality of image-processed target tile images.

15. The apparatus of claim 14, wherein the first motion information estimating unit estimates the first motion information using a cumulative pixel value of the reference image and a cumulative pixel value of the target image in a horizontal direction and a vertical direction.

16. The apparatus of claim 15, wherein the first motion information estimating unit estimates the first motion information by matching the cumulative pixel value of the reference image and the cumulative pixel value of the target image in the horizontal direction and the vertical direction.

17. The apparatus of claim 14, wherein the tile image processing unit performs the image processing on a target tile image, of the plurality of target tiles images, based on an image hierarchy structure of a reference tile image and an image hierarchy structure of the target tile image, and
wherein the tile image processing unit applies a result of the image processing with respect to at least one of image channels configuring a reference tile image or a target tile image to an image processing performed on a remainder of the image channels.

18. The apparatus of claim 17, wherein the tile image processing unit performs the image processing on a target tile image of a highest level in the image hierarchy structure of the target tile image using the first motion information,
wherein the tile image processing unit performs the image processing on a target tile image of a subsequent level in the image hierarchy structure of the target tile image using a result of image processing derived from a previous level, and
wherein the tile image processing unit performs the image processing on a target tile image of a subsequent level in the image hierarchy structure of the target tile image using a result of image processing derived from a previous level.

19. The apparatus of claim 17, wherein the tile image processing unit comprises:
a second motion information estimating unit to estimate second motion information indicating a degree of motion of the target tile image with respect to the reference tile image using the first motion information;
a block area dividing unit to divide the reference tile image and the target tile image into a plurality of block areas; and
a block area detecting unit to detect a block area of the target tile image that matches a block area of the reference tile image using the second motion information.

20. The apparatus of claim 14, further comprising:
a brightness adjusting unit to adjust a brightness of the target image to match a brightness of the reference image, and
wherein the brightness adjusting unit adjusts a brightness of the target image using a brightness adjustment relationship between the reference image and the target image derived from a histogram.

21. An image processing method comprising:
estimating, by way of a processor, motion information between a plurality of input images by estimating a cumulative pixel value of each of the plurality of input images in a predetermined direction;
dividing each of the plurality of input images into a plurality of sub-images;
performing image processing on the plurality of sub-images using the estimated motion information; and
combining the image-processed sub-images into a single output image.

22. The method of claim 21, wherein in the estimating of the motion information, a cumulative image one-dimensional (1D) curve is generated, representing a cumulative pixel value in the predetermined direction, with respect to the plurality of input images, and the motion information is estimated using the cumulative image 1D curve.
